(19) United States
(12) Patent Application Publication
(10) Pub. No.: US 2025/0330983 A1
(43) Pub. Date: Oct. 23, 2025

(54) DATA COLLECTION METHOD, DATA GENERATION APPARATUS, MODEL DEPLOYMENT APPARATUS AND DATA COLLECTION INITIATING APPARATUS

(71) Applicant: FUJITSU LIMITED, Kawasaki-shi (JP)

(72) Inventors: Yujia SHAN, Beijing (CN); Gang SUN, Beijing (CN)

(73) Assignee: FUJITSU LIMITED, Kawasaki-shi (JP)

(21) Appl. No.: 19/256,443

(22) Filed: Jul. 1, 2025

Related U.S. Application Data
(63) Continuation of application No. PCT/CN2023/071593, filed on Jan. 10, 2023.

(51) Int. Cl. H04W 72/20; H04W 64/00

(52) U.S. Cl. CPC H04W 72/20; H04W 64/00

(57) ABSTRACT

A data generation apparatus includes: a transmitter configured to transmit request information for collecting data to a model deployment apparatus; and a receiver configured to receive AI/ML model-related information from the model deployment apparatus; wherein the transmitter is further configured to transmit data to the model deployment apparatus according to the AI/ML model-related information.

### CROSS-REFERENCE TO RELATED APPLICATION

This application is a continuation application under 35 U.S.C. 111(a) of International Patent Application PCT/CN2023/071593 filed on Jan. 10, 2023, and designated the U.S., the entire contents of which are incorporated herein by reference.

### TECHNICAL FIELD

The present disclosure relates to the field of communication technologies.

### BACKGROUND

With commercialization of the fifth generation (5G) communication, especially large-scale expansion of the industrial Internet industry, the demand for positioning of terminal equipments in wireless communication has significantly increased. Traditional wireless positioning is based on multiple technologies, what is directly related to 5G NR (New Radio) mainly is positioning methods for performing estimation using a channel measurement result between a network entity and a terminal, such as TDOA (Time Difference Of Arrival), E-CID (Enhanced Cell ID) and Multi-RTT (Multi-Round-Trip Time). These traditional positioning methods all have several inherent defects, resulting in poorer positioning accuracy of a terminal equipment in different wireless environments or scenarios, in particular in a wireless environment with more severe non-line-of-sight (NLOS), such as an indoor factory (InF). In such environments, error values of traditional positioning methods are very large, which is generally difficult to be accepted. A root cause is that a positioning method based on wireless channel measurement is only effective in a line-of-sight (LOS) environment, a wireless channel measurement value obtained in a non-line-of-sight environment has a larger deviation from an ideal value, while the accuracy of a terminal positioning result directly depends on this measurement value. Therefore, the measurement error leads to occurrence of a final terminal positioning result error.

In recent years, artificial intelligence machine learning (AI/ML) technology, represented by deep learning, has developed rapidly, and has been applied to many research and commercial fields because of its powerful nonlinear fitting capability. Similarly, evaluation performance of artificial intelligence application in wireless positioning has also been greatly improved compared with traditional methods.

However, due to complexity and variability of wireless communication environments and inherent characteristics of a big data-based AI/ML model for wireless positioning, generalization ability (consistency of performing inference operations using the same model in different environments) performance of the AI/ML model is poorer. When the performance of the AI/ML model cannot achieve high positioning accuracy in a current wireless environment, or is insufficient to satisfy an accuracy demand of current wireless application for terminals, applicability of the AI/ML model needs to be determined in real time, and for an AI/ML model whose performance is poor, operations such as switching, optimizing, or falling back to a non-AI/ML traditional method are performed.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

However, the inventor finds that since the AI/ML model is a big data-based implementation technology, various decisions on the AI/ML model need to be made based on data that can represent a current channel environment or a model property. Collection and application of these data need to be managed via a signaling procedure, especially for an AI/ML model required for wireless positioning application, performance cannot be monitored only by comparing outputs of the model with a traditional method having the same function, model management may only be performed by means of collecting data (especially model input data) in real time. Wireless positioning process defined in the current 3GPP protocol does not involve a concept related to the AI/ML model, hence, this series of data collection processes is not clearly defined in the current protocol.

Addressed to at least one of the above problems, the embodiments of the present disclosure provide a data collection method, a data generation apparatus, a model deployment apparatus and a data collection initiating apparatus. Data collection and configuration are able to be performed between positioning-involved network entities and/or between a network entity and a terminal which are involved in positioning, so as to optimize a wireless positioning AI/ML model and obtain a more accurate positioning result.

According to one aspect of the embodiments of the present disclosure, a data collection method is provided, including:
a data generation apparatus transmits request information for collecting data to a model deployment apparatus;
the data generation apparatus receives AI/ML model-related information from the model deployment apparatus; and
the data generation apparatus transmits data to the model deployment apparatus according to the AI/ML model-related information.

According to another aspect of the embodiments of the present disclosure, a data generation apparatus is provided, including:
a first transmitting unit configured to transmit request information for collecting data to a model deployment apparatus; and
a first receiving unit configured to receive AI/ML model-related information from the model deployment apparatus,
the first transmitting unit further transmits data to the model deployment apparatus according to the AI/ML model-related information.

According to a further aspect of the embodiments of the present disclosure, a data collection method is provided, including:
a model deployment apparatus receives request information for collecting data transmitted by a data generation apparatus;
the model deployment apparatus transmits AI/ML model-related information to the data generation apparatus; and
the model deployment apparatus receives data transmitted by the data generation apparatus according to the AI/ML model-related information.

According to another aspect of the embodiments of the present disclosure, a model deployment apparatus is provided, including:
a second receiving unit configured to receive request information for collecting data transmitted by a data generation apparatus; and
a second transmitting unit configured to transmit AI/ML model-related information to the data generation apparatus,
the second receiving unit further receives data transmitted by the data generation apparatus according to the AI/ML model-related information.

According to a further aspect of the embodiments of the present disclosure, a data collection method is provided, including:
a data collection initiating apparatus transmits starting signaling for indicating to perform data collection to a data generation apparatus,
wherein the data generation apparatus transmits request information for collecting data to a model deployment apparatus, receives AI/ML model-related information from the model deployment apparatus, and transmits data to the model deployment apparatus according to the AI/ML model-related information.

According to a further aspect of the embodiments of the present disclosure, a data collection initiating apparatus is provided, including:
a third transmitting unit configured to transmit starting signaling for indicating to perform data collection to a data generation apparatus,
wherein the data generation apparatus transmits request information for collecting data to a model deployment apparatus, receives AI/ML model-related information from the model deployment apparatus, and transmits data to the model deployment apparatus according to the AI/ML model-related information.

One of advantageous effects of the embodiments of the present disclosure lies in that: the data generation apparatus transmits request information for collecting data to a model deployment apparatus, receives AI/ML model-related information from the model deployment apparatus, and transmits data to the model deployment apparatus according to the AI/ML model-related information, thereby, real-time data collection is able to be performed between positioning-involved network entities and/or between a network entity and a terminal which are involved in positioning, so as to optimize modules in each lifecycle management framework such as supervision, re-selection, training and inference of a wireless positioning AI/ML model, so that performance of the AI/ML model for wireless positioning is better and generalization thereof is better, whereby a terminal is able to obtain a more accurate positioning result.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or illustrated with respect to one implementation may be used in the same way or in a similar way in one or more other implementations and in combination with or instead of the features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other drawings according to these drawings under the premise that they do not pay inventive labor. In the drawings:

FIG. 1 is a schematic diagram of an application scenario of the embodiments of the present disclosure;

FIG. 2 is a schematic diagram of a data collection method in the embodiments of the present disclosure;

FIG. 3 is another schematic diagram of a data collection method in the embodiments of the present disclosure;

FIG. 4 is another schematic diagram of a data collection method in the embodiments of the present disclosure;

FIG. 5 is another schematic diagram of a data collection method in the embodiments of the present disclosure;

FIG. 6 is another schematic diagram of a data collection method in the embodiments of the present disclosure;

FIG. 7 is a schematic diagram of a data generation apparatus in the embodiments of the present disclosure;

FIG. 8 is a schematic diagram of a model deployment apparatus in the embodiments of the present disclosure;

FIG. 9 is a schematic diagram of a data collection initiating apparatus in the embodiments of the present disclosure; and

FIG. 10 is a schematic diagram of an electronic device in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and future 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP) node, a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “a User Equipment (UE)” refers to, for example, a device that accesses a communication network and receives network services through a network device, or may also be called “Terminal Equipment (TE)”. The terminal equipment may be fixed or mobile, and may also be called a Mobile Station (MS), a terminal, a user, a Subscriber Station (SS), an Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Scenarios of the embodiments of the present disclosure are described through the following examples, however the present disclosure is not limited to these.

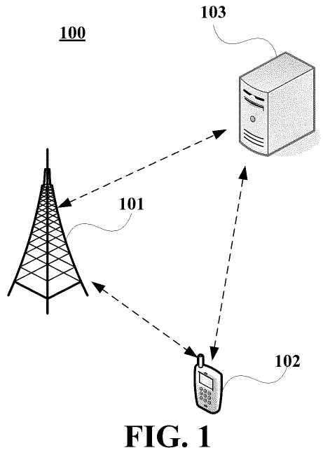

FIG. 1 is a schematic diagram of a communication system in the embodiments of the present disclosure, schematically describes situations by taking a terminal equipment and a network device as examples. As shown in FIG. 1, the communication system 100 may include a network device 101, a terminal equipment 102 and a positioning server 103. For simplicity, FIG. 1 only takes one terminal equipment and one network device as examples for description, however the embodiments of the present disclosure are not limited to this.

In the embodiments of the present disclosure, transmission of existing or further implementable services may be carried out between the network device 101 and the terminal equipment 102. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that the terminal equipment 102 is within the coverage of network device 101, but the present disclosure is not limited to this. The terminal equipment 102 may not be within the coverage of network device 101. In addition, FIG. 1 takes “the positioning server 103 is deployed separately” as an example for description, an AI model may be run in the positioning server 103 to obtain a positioning result; however the present disclosure is not limited to this, the positioning server 103 may be deployed in a core network, may be deployed in the network device 102 (such as a base station), or may be deployed in the terminal equipment 103; the embodiments of the present disclosure do not limit these situations.

In the embodiments of the present disclosure, the terminal equipment to be positioned may be called a target device, and the function of the positioning server is called a Location Management Function (LMF). The LMF may be a network entity that positions and manages terminals, or a location server that has the location management function may be called LMF for short. In a case where there is no confusion, the terms “LMF” and “location server” are replaced mutually. For specific contents of these concepts and positioning, relevant technologies may be referred to.

Input data for wireless positioning supported by the current 3GPP protocol (TS38.305/38.214/38.331, etc.) include: an inherent configuration attribute in a wireless network, such as E-CID; wireless measurement data (such as RTT, AoD/AoA, RSTD, RSRP) obtained by a reference signal (RS). For an AI/ML model training phase, required data includes model input (INPUT) and data as labels (GROUND TRUTH), there are many types, ways and channels of collection. The information need to perform signaling communication and configuration between a model deployment entity and a data generation entity, current technologies have no corresponding solution.

In the embodiments of the present disclosure, the model deployment apparatus may be a UE, gNB or LMF, or may be part of a function or entity of any of the above devices. The data generation apparatus may be a UE, gNB, Positioning Reference Unit (PRU) or LMF, or may be part of a function or entity of any of the above devices. The data collection initiating apparatus may be a gNB or LMF, or may be part of a function or entity of any of the above devices. In addition, the above apparatuses may be a combination of multiple entities, for example, the data generation apparatus may be composed of a gNB alone or be jointly composed of a gNB+a PRU; the present disclosure is not limited to this.

### Embodiments of a First Aspect

Embodiments of the present disclosure provide a data collection method, which is described from a data generation apparatus side. The data generation apparatus may be a network device (such as a base station), or may be a terminal equipment (such as a target device, a PRU or other terminal), or may further be a location server having an LMF function.

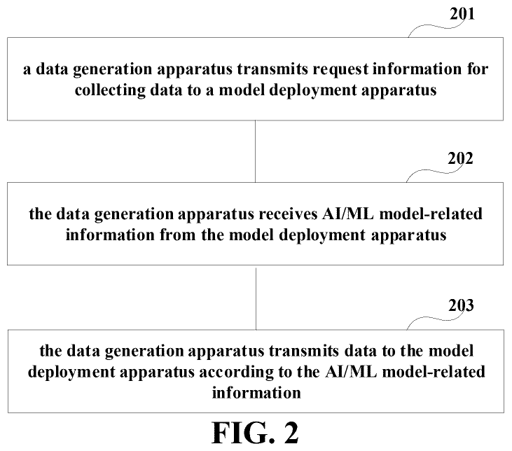

FIG. 2 is a schematic diagram of a data collection method in the embodiments of the present disclosure. As shown in FIG. 2, the method includes:
201, a data generation apparatus transmits request information for collecting data to a model deployment apparatus;
202, the data generation apparatus receives AI/ML model-related information from the model deployment apparatus; and
203, the data generation apparatus transmits data to the model deployment apparatus according to the AI/ML model-related information.

It should be noted that the above FIG. 2 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 2.

Thereby, the data generation apparatus transmits request information for collecting data to a model deployment apparatus, receives AI/ML model-related information from the model deployment apparatus, and transmits data to the model deployment apparatus according to the AI/ML model-related information. Real-time data collection is able to be performed between positioning-involved network entities and/or between a network entity and a terminal which are involved in positioning, so as to optimize a wireless positioning AI/ML model, performance of the AI/ML model for wireless positioning is better or generalization thereof is better, whereby a more accurate positioning result is able to be obtained.

In some embodiments, the data generation apparatus receives starting signaling for indicating to perform data collection from a data collection initiating apparatus.

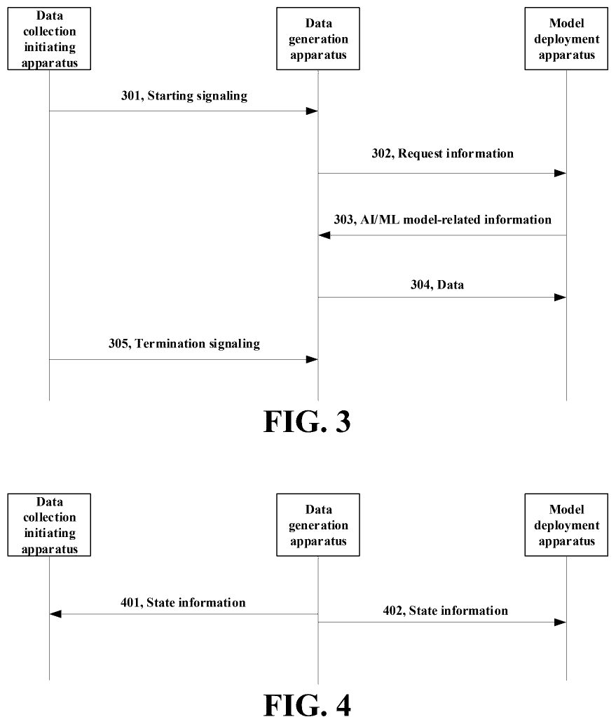

FIG. 3 is another schematic diagram of a data collection method in the embodiments of the present disclosure. As shown in FIG. 3, the method includes:
301, a data generation apparatus receives starting signaling for indicating to perform data collection from a data collection initiating apparatus;
302, the data generation apparatus transmits request information for collecting data to a model deployment apparatus;
303, the data generation apparatus receives AI/ML model-related information from the model deployment apparatus; and
304, the data generation apparatus transmits data to the model deployment apparatus according to the AI/ML model-related information.

In some embodiments, the starting signaling includes first triggering information, or the starting signaling includes first triggering information and first cause information associated with the first triggering information.

For example, the data collection initiating apparatus is a UE, and the data generation apparatus is a gNB (or + a PRU). The UE initiates data collection starting signaling to the gNB via uplink control information (UCI) or a physical uplink shared channel (PUSCH). The starting signaling is, for example, 1 bit and several bits.

For another example, the data collection initiating apparatus is a UE, and the data generation apparatus is a gNB (or +a PRU). The UE initiates data collection starting signaling to the gNB via uplink control information (UCI) or a physical uplink shared channel (PUSCH). The starting signaling is, for example, an IE including cause information.

In some embodiments, the first cause information includes at least one of the following: cell handover, a change in a beam environment, a change in a transmit beam, a change in an AI/ML model lifecycle management phase (such as training, monitoring, inference), a change in a positioning service quality demand, upgrading of a positioning module, or inability of a preferred device to provide positioning data.

For example, it may include some common causes, such as cell handover, a change in a beam environment, etc.; or a change in a quality of service (QOS) demand corresponding to a positioning service; or upgrading of a positioning-related module, etc.; or other inability of a preferred gNB 5 (such as a primary cell) to provide positioning-related data, etc.; or other AI/ML causes, etc.

Table 1 shows an example of data collection initiating signaling.

TABLE 1

| DataCollectionRequest:: = Sequence { | |
|---|---|
| DataCollectionCommand | ENUMERATE{0,1} |
| DataCollectionPurpose | DataCollectionPurpose |

```
  ...
}
  DataCollectionPurpose:: = Sequence {
  DataCellctionTrigger
  ENUMERATE{“cell_switch”, “tx_beam change”, ...}
  Purporse-DataCollection
  ENUMERATE{“training”, “monitoring”, “inference”,...}
}
```

Table 1 exemplifies the situation of initiating data collection using IE, but the present disclosure is not limited to this, for example, other IE or a new defined IE may further be used. In addition, content in this signaling may further be adjusted according to an actual need.

In some embodiments, as shown in FIG. 3, the method may further include:
305, the data generation apparatus receives termination signaling for indicating termination of data collection from the data collection initiating apparatus.

In some embodiments, the termination signaling includes second triggering information, or the termination signaling includes second triggering information and second cause information associated with the second triggering information.

For example, the data collection initiating apparatus is a UE, and the data generation apparatus is a gNB (or + a PRU). The UE initiates termination signaling for data collection termination to the gNB via uplink control information (UCI) or a physical uplink shared channel (PUSCH). The termination signaling is, for example, 1 bit or several bits.

For another example, the data collection initiating apparatus is a UE, and the data generation apparatus is a gNB (or +a PRU). The UE initiates termination signaling for data collection termination to the gNB via uplink control information (UCI) or a physical uplink shared channel (PUSCH). The termination signaling is, for example, an IE including cause information.

In some embodiments, the second cause information includes at least one of the following: completion of data collection, termination of a current wireless positioning service, termination of an AI/ML model service, handover of a cell where the model deployment apparatus is located, a change in a beam environment to which the model deployment apparatus or the data generation apparatus corresponds, or a change in a positioning service quality demand.

For example, the cause information includes: completion of data collection; or termination of a current positioning service; or other AI/ML causes.

It should be noted that the above FIG. 3 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 3.

The above text schematically describes interaction between the data generation apparatus and the data collection initiating apparatus, and the following text schematically describes interaction between the data generation apparatus and the model deployment apparatus.

In some embodiments, the data generation apparatus periodically transmits the request information to the model deployment apparatus, or the data generation apparatus aperiodically transmits the request information to the model deployment apparatus.

In some embodiments, the request information includes triggering request information, or includes triggering request information and additional request information.

For example, the data generation apparatus requests relevant information from the model deployment apparatus, may only transmit REQUEST signaling, or may attach specific content. By taking the data generation apparatus being a gNB and the model deployment apparatus being a UE as an example, the gNB may initiate request signaling for data collection configuration information to the UE via downlink control information (DCI) or a media access control (MAC) control element (CE). The request signaling may be 1 bit or several bits, or may be an IE that includes additional information.

In some embodiments, the additional request information includes at least one of the following: data size information, data consistency requirement information, data content information, collection duration information, data quality determination information, data format information, data type information, positioning reference unit (PRU) information, or non-radio access technology (NON-RAT) information.

For example, the additional request information may be appended via a specified field in RRC or MAC CE corresponding to model identification, or other RRC signaling or MAC CE not defined in model identification-related signaling may be customized to specify this additional request information.

Table 2 shows an example of additional request information.

TABLE 2

| DataCollectionAdditionalInfo:: = Sequence { | |
|---|---|
| DataSizeInfo | ... |
| DataConsistencyInfo... | |
| DataCollectionTimeInfo... | |
| PRU-Info | ... |
| Non-RAT-Info | ... |

...
}

Table 2 exemplifies additional request information, but the present disclosure is not limited to this, for example, other IE or a new defined IE may further be used. In addition, specific content may further be adjusted according to an actual need.

Table 3 shows an example of data consistency requirement information.

TABLE 3

| DataConsistencyInfo: :: = Sequence { | |
|---|---|
| DataConsistencyType | |
| ENUMERATED{‘cir’ , ‘losnlos', ‘rsrp’,...,} | |
| CIR-consistency | CIR-consistency |
| LOS-NLOS-consistency | LOS-NLOS-consistency |
| RSRP-consistency | RSRP-consistency |

...
}

Table 3 exemplifies data consistency requirement information, but the present disclosure is not limited to this, for example, other IE or a new defined IE may further be used. In addition, specific content may further be adjusted according to an actual need.

In some embodiments, in a case where the data collection initiating apparatus and the model deployment apparatus are located in the same device, the AI/ML model-related information and the starting signaling are transmitted together by the device, or in a case where the data collection initiating apparatus and the model deployment apparatus are not located in the same device, the AI/ML model-related information is transmitted by the model deployment apparatus based on the request information.

In some embodiments, the AI/ML model-related information includes at least one of the following: model configuration information, model input output information, model training information, model inference information, model monitoring information, or information needed for model handover. The present disclosure is not limited to this, it may be any combination of the above information, or may further include other information.

In some embodiments, the model configuration information includes general information and/or positioning-specific information.

For example, the general information (GENERAL INFO) includes: data size information, data collection time span information, etc. (basic information such as a type of INPUT has been reported by MODEL IDENTIFICATION). The positioning-specific information (POS-SPECIFIC INFO) includes: specifying a range in which a PRU may be applied, specifying a mode of a NON-RAT method, specifying a performance monitoring rule corresponding to each model input, etc.

In some embodiments, the general information includes at least one of the following: data size information, data consistency requirement information, collection duration information, or time limit information.

For example, the data size information includes at least one of the following: the number of needed valid data, the number of needed samples, or a minimum data amount of needed data.

For another example, the time limit information includes maximum delay needed for receiving data, taking ms as the unit.

For another example, the above information may be combined, at the same time, a minimum data amount and maximum delay needed are provided, data collection satisfies these two conditions.

For a further example, the data consistency requirement information includes at least one of the following: information on a change of a mean value of RSRP in a plurality of measurement cycles, information on a change of delay distribution of RSRP, or configuration consistency information of a reference signal for data measurement.

In some embodiments, the positioning-specific information includes at least one of the following: data source information, processing information needed for data transmission, or data quality information.

For example, the data source information includes at least one of the following: cell identification information, non-radio access technology (NON-RAT) positioning manner information, identification information of a positioning reference unit (PRU), or beam information to which the positioning reference unit (PRU) corresponds. For example, if data is collected via MULTIPLE gNBs, a CELL ID corresponding to the gNB may be specified. If data is collected via a PRU, a PRU ID or a BEAM ID corresponding to the PRU may be specified. If data is collected via NON-RAT, a specific positioning manner needs to be specified.

For another example, the processing information needed for data transmission includes at least one of the following: information specifying whether data need to be segmented, or information specifying whether the data need to be header compressed.

For a further example, the data quality information including at least one of the following: information that reference signal received power (RSRP) is greater than a preset power threshold, information that a plurality of paths of reference signal received path power (RSRPP) are within a preset duration, or information that a probability of a LOS is greater than a preset proportion.

For example, an absolute quality requirement of data required may be specified, for example RSRP is greater than a certain power threshold, or the first N paths of RSRPP are within M milliseconds, a LOS probability is greater than P %, and so on. For another example, a relative quality requirement of data required may be specified, for example the above absolute value is converted to a relative value; a relative physical quantity may serve as a threshold, or it may be designed as a percentage way.

In some embodiments, the data generation apparatus transmits state information of data collection to the data collection initiating apparatus or the model deployment apparatus.

FIG. 4 is another schematic diagram of a data collection method in the embodiments of the present disclosure, showing a situation of state information interaction. FIG. 4 may be executed alone or in combination with FIG. 3. As shown in FIG. 4, the method includes:
401, the data generation apparatus transmits state information of data collection to the data collection initiating apparatus; and
402, the data generation apparatus transmits state information of data collection to the model deployment apparatus.

In some embodiments, the state information includes: a data collection completion indication or a data collection abnormality indication, wherein the data collection abnormality indication includes common cause information and/or positioning-related cause information.

It should be noted that the above FIG. 4 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 4.

In some embodiments, the common cause information includes at least one of the following: an insufficient processing capability per unit time, or an insufficient resource capability; the positioning-related cause information includes at least one of the following: an inability to provide specified positioning data, an inability to generate data of specified accuracy, or unavailability of a positioning reference unit (PRU).

For example, the data generation apparatus is located in a gNB, and the data collection initiating apparatus is located in a UE. The gNB transmits data collection state information to the UE via RRC signaling, DCI or a MAC CE, content of which may include: an indication that data collection is completed, or an indication that data collection is abnormal. The indication that data collection is abnormal may include: AI/ML model general anomaly information, such as an insufficient processing capability per unit time; AI/ML model-specific anomaly information for positioning, such as an inability to provide a specified positioning data generation mode, an inability to generate data of specified accuracy, or unavailability of a PRU, and so on.

Table 4 shows an example of data collection abnormality indication.

TABLE 4

```
DataCollectionStatusInfo-Pos: ::= ENUMERATED {
  ‘no-dedicated-data-generation-method’,
  ‘not accurate enough’,
  ‘no PRU available’,
  ...
}
```

Table 4 exemplifies positioning-specific data collection state information, but the present disclosure is not limited to this, for example, other IE or a new defined IE may further be used. In addition, specific content may further be adjusted according to an actual need.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection is able to be performed between positioning-involved network entities and/or between a network entity and a terminal which are involved in positioning, so as to optimize a wireless positioning AI/ML model, performance of the AI/ML model for wireless positioning is better or generalization thereof is better, whereby a more accurate positioning result is able to be obtained.

### Embodiments of a Second Aspect

Embodiments of the present disclosure provide a data collection method, which is described from a model deployment apparatus side. Embodiments of the second aspect correspond to the embodiments of the first aspect, the same contents are not repeated.

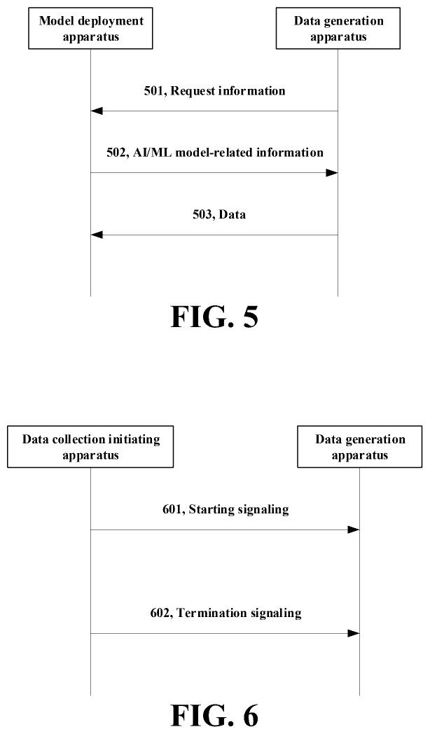

FIG. 5 is another schematic diagram of a data collection method in the embodiments of the present disclosure. As shown in FIG. 5, the method includes:
501, a model deployment apparatus receives request information for collecting data transmitted by a data generation apparatus;
502, the model deployment apparatus transmits AI/ML model-related information to the data generation apparatus; and
503, the model deployment apparatus receives data transmitted by the data generation apparatus according to the AI/ML model-related information.

It should be noted that the above FIG. 5 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 5.

In some embodiments, the data generation apparatus periodically transmits the request information to the model deployment apparatus, or the data generation apparatus aperiodically transmits the request information to the model deployment apparatus.

In some embodiments, the request information includes triggering request information, or includes triggering request information and additional request information.

In some embodiments, the additional request information includes at least one of the following: data size information, data consistency requirement information, data content information, collection duration information, data quality determination information, data format information, data type information, positioning reference unit (PRU) information, or non-radio access technology (NON-RAT) information.

In some embodiments, the AI/ML model-related information includes at least one of the following: model configuration information, model input output information, model training information, model inference information, model monitoring information, or information needed for model handover.

In some embodiments, the model configuration information includes general information and/or positioning-specific information.

In some embodiments, the general information includes at least one of the following: data size information, data consistency requirement information, collection duration information, or time limit information.

In some embodiments, the data size information includes at least one of the following: the number of needed valid data, the number of needed samples, or a minimum data amount of needed data;
the time limit information including maximum delay needed for receiving data;
the data consistency requirement information including at least one of the following: information on a change of a mean value of RSRP in a plurality of measurement cycles, information on a change of delay distribution of RSRP, or configuration consistency information of a reference signal for data measurement.

In some embodiments, the positioning-specific information includes at least one of the following: data source information, processing information needed for data transmission, or data quality information.

In some embodiments, the data source information includes at least one of the following: cell identification information, non-radio access technology (NON-RAT) positioning manner information, identification information of a positioning reference unit (PRU), or beam information to which the positioning reference unit (PRU) corresponds;
the processing information needed for data transmission including at least one of the following: information specifying whether data need to be segmented, or information specifying whether the data need to be header compressed;
the data quality information including at least one of the following: information that RSRP is greater than a preset power threshold, information that a plurality of paths of RSRPP are within a preset duration, or information that a probability of a LOS is greater than a preset proportion.

In some embodiments, the model deployment apparatus receives state information for data collection from the data generation apparatus.

In some embodiments, the state information includes: a data collection completion indication or a data collection abnormality indication, wherein the data collection abnormality indication includes common cause information and/or positioning-related cause information.

In some embodiments, the common cause information includes at least one of the following: an insufficient processing capability per unit time, or an insufficient resource capability; the positioning-related cause information includes at least one of the following: an inability to provide specified positioning data, an inability to generate data of specified accuracy, or unavailability of a positioning reference unit (PRU).

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection is able to be performed between positioning-involved network entities and/or between a network entity and a terminal which are involved in positioning, so as to optimize a wireless positioning AI/ML model, performance of the AI/ML model for wireless positioning is better or generalization thereof is better, whereby a more accurate positioning result is able to be obtained.

### Embodiments of a Third Aspect

Embodiments of the present disclosure provide a data collection method, which is described from a data collection initiating apparatus side. Embodiments of the third aspect correspond to the embodiments of the first aspect, the same contents are not repeated.

FIG. 6 is another schematic diagram of a data collection method in the embodiments of the present disclosure. As shown in FIG. 6, the method includes:
601, a data collection initiating apparatus transmits starting signaling for indicating to perform data collection to a data generation apparatus,
wherein the data generation apparatus transmits request information for collecting data to a model deployment apparatus, receives AI/ML model-related information from the model deployment apparatus, and transmits data to the model deployment apparatus according to the AI/ML model-related information.

As shown in FIG. 6, the method may further include:
602, the data collection initiating apparatus transmits termination signaling for indicating termination of data collection to the data generation apparatus.

It should be noted that the above FIG. 6 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 6.

In some embodiments, the starting signaling includes first triggering information, or the starting signaling includes first triggering information and first cause information associated with the first triggering information.

In some embodiments, the first cause information includes at least one of the following: cell handover, a change in a beam environment, a change in a transmit beam, a change in an AI/ML model lifecycle management phase (such as training, monitoring, inference, etc.), a change in a positioning service quality demand, upgrading of a positioning module, or inability of a preferred device to provide positioning data.

In some embodiments, the termination signaling includes second triggering information, or the termination signaling includes second triggering information and second cause information associated with the second triggering information.

In some embodiments, the second cause information includes at least one of the following: completion of data collection, termination of a current wireless positioning service, termination of an AI/ML model service, handover of a cell where the model deployment apparatus is located, a change in a beam environment to which the model deployment apparatus or the data generation apparatus corresponds, or a change in a positioning service quality demand.

In some embodiments, in a case where the data collection initiating apparatus and the model deployment apparatus are located in the same device, the AI/ML model-related information and the starting signaling are transmitted together by the device, or in a case where the data collection initiating apparatus and the model deployment apparatus are not located in the same device, the AI/ML model-related information is transmitted by the model deployment apparatus based on the request information.

In some embodiments, the data collection initiating apparatus receives state information for data collection from the data generation apparatus.

In some embodiments, the state information includes: a data collection completion indication or a data collection abnormality indication, wherein the data collection abnormality indication includes common cause information and/or positioning-related cause information.

In some embodiments, the common cause information includes at least one of the following: an insufficient processing capability per unit time, or an insufficient resource capability; the positioning-related cause information includes at least one of the following: an inability to provide specified positioning data, an inability to generate data of specified accuracy, or unavailability of a positioning reference unit (PRU).

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection is able to be performed between positioning-involved network entities and/or between a network entity and a terminal which are involved in positioning, so as to optimize a wireless positioning AI/ML model, performance of the AI/ML model for wireless positioning is better or generalization thereof is better, whereby a more accurate positioning result is able to be obtained.

### Embodiments of a Fourth Aspect

Embodiments of the present disclosure provide a data generation apparatus. The principle of the data generation apparatus to solve a problem is the same as the method in the embodiments of the first aspect, thus its specific implementation may refer to the embodiments of the first aspect, the same contents are not repeated.

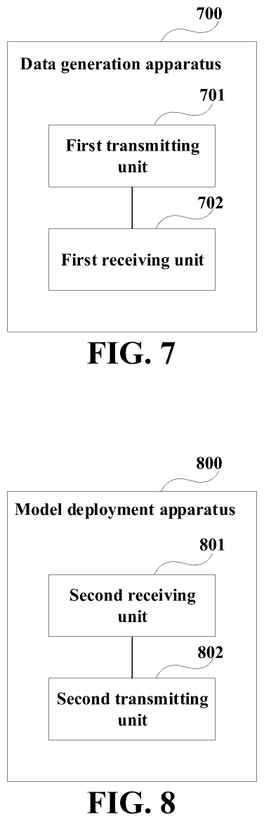

FIG. 7 is a schematic diagram of a data generation apparatus in the embodiments of the present disclosure. As shown in FIG. 7, a data generation apparatus 700 in the embodiments of the present disclosure includes:

a first transmitting unit 701 (which may also be called a transmitter) configured to transmit request information for collecting data to a model deployment apparatus; and

a first receiving unit 702 (which may also be called a receiver) configured to receive AI/ML model-related information from the model deployment apparatus, and the first transmitting unit 701 further transmits data to the model deployment apparatus according to the AI/ML model-related information.

In some embodiments, the first receiving unit 702 further receives starting signaling for indicating to perform data collection from a data collection initiating apparatus.

In some embodiments, the starting signaling includes first triggering information, or the starting signaling includes first triggering information and first cause information associated with the first triggering information.

In some embodiments, the first cause information includes at least one of the following: cell handover, a change in a beam environment, a change in a transmit beam, a change in an AI/ML model lifecycle management phase (such as training, monitoring, inference, etc.), a change in a positioning service quality demand, upgrading of a positioning module, or inability of a preferred device to provide positioning data.

In some embodiments, the first receiving unit 702 further receives termination signaling for indicating termination of data collection from the data collection initiating apparatus.

In some embodiments, the termination signaling includes second triggering information, or the termination signaling includes second triggering information and second cause information associated with the second triggering information.

In some embodiments, the second cause information includes at least one of the following: completion of data collection, termination of a current wireless positioning service, termination of an AI/ML model service, handover of a cell where the model deployment apparatus is located, a change in a beam environment to which the model deployment apparatus or the data generation apparatus corresponds, or a change in a positioning service quality demand.

In some embodiments, the first transmitting unit 701 periodically transmits the request information to the model deployment apparatus, or the first transmitting unit 701 aperiodically transmits the request information to the model deployment apparatus.

In some embodiments, the request information includes triggering request information, or includes triggering request information and additional request information.

In some embodiments, the additional request information includes at least one of the following: data size information, data consistency requirement information, data content information, collection duration information, data quality determination information, data format information, data type information, positioning reference unit (PRU) information, or non-radio access technology (NON-RAT) information.

In some embodiments, the AI/ML model-related information includes at least one of the following: model configuration information, model input output information, model training information, model inference information, model monitoring information, or information needed for model handover.

In some embodiments, the model configuration information includes general information and/or positioning-specific information.

In some embodiments, the general information includes at least one of the following: data size information, data consistency requirement information, collection duration information, or time limit information;

the data size information including at least one of the following: the number of needed valid data, the number of needed samples, or a minimum data amount of needed data, the time limit information including maximum delay needed for receiving data;

the data consistency requirement information including at least one of the following: information on a change of a mean value of RSRP in a plurality of measurement cycles, information on a change of delay distribution of RSRP, or configuration consistency information of a reference signal for data measurement.

In some embodiments, the positioning-specific information includes at least one of the following: data source information, processing information needed for data transmission, or data quality information;

the data source information including at least one of the following: cell identification information, non-radio access technology positioning manner information, identification information of a positioning reference unit, or beam information to which the positioning reference unit corresponds, the processing information needed for data transmission including at least one of the following: information specifying whether data need to be segmented, or information specifying whether the data need to be header compressed;

the data quality information including at least one of the following: information that RSRP is greater than a preset power threshold, information that a plurality of paths of RSRPP are within a preset duration, or information that a probability of a LOS is greater than a preset proportion.

In some embodiments, in a case where the data collection initiating apparatus and the model deployment apparatus are located in the same device, the AI/ML model-related information and the starting signaling are transmitted together by the device, or in a case where the data collection initiating apparatus and the model deployment apparatus are not located in the same device, the AI/ML model-related information is transmitted by the model deployment apparatus based on the request information.

In some embodiments, the first transmitting unit 701 further transmits state information of data collection to the data collection initiating apparatus or the model deployment apparatus.

In some embodiments, the state information includes: a data collection completion indication or a data collection abnormality indication, wherein the data collection abnormality indication includes common cause information and/or positioning-related cause information.

In some embodiments, the common cause information includes at least one of the following: an insufficient processing capability per unit time, an insufficient resource capability; the positioning-related cause information includes at least one of the following: an inability to provide specified positioning data, an inability to generate data of specified accuracy, or unavailability of a positioning reference unit.

Moreover, for the sake of simplicity, FIG. 7 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection is able to be performed between positioning-involved network entities and/or between a network entity and a terminal which are involved in positioning, so as to optimize a wireless positioning AI/ML model, performance of the AI/ML model for wireless positioning is better or generalization thereof is better, whereby a more accurate positioning result is able to be obtained.

### Embodiments of a Fifth Aspect

Embodiments of the present disclosure provide a model deployment apparatus. The principle of the model deployment apparatus to solve a problem is the same as the method in the embodiments of the second aspect, thus its specific implementation may refer to the embodiments of the first and second aspects, the same contents are not repeated.

FIG. 8 is a schematic diagram of a model deployment apparatus in the embodiments of the present disclosure. As shown in FIG. 8, a model deployment apparatus 800 in the embodiments of the present disclosure includes:

a second receiving unit 801 configured to receive request information for collecting data transmitted by a data generation apparatus; and

a second transmitting unit 802 configured to transmit AI/ML model-related information to the data generation apparatus, and the second receiving unit 801 further receives data transmitted by the data generation apparatus according to the AI/ML model-related information.

In some embodiments, the second receiving unit 801 further receives state information for data collection from the data generation apparatus.

Moreover, for the sake of simplicity, FIG. 8 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection is able to be performed between positioning-involved network entities and/or between a network entity and a terminal which are involved in positioning, so as to optimize a wireless positioning AI/ML model, performance of the AI/ML model for wireless positioning is better or generalization thereof is better, whereby a more accurate positioning result is able to be obtained.

### Embodiments of a Sixth Aspect

Embodiments of the present disclosure provide a data collection initiating apparatus. The principle of the data collection initiating apparatus to solve a problem is the same as the method in the embodiments of the third aspect, thus its specific implementation may refer to the embodiments of the first to third aspects, the same contents are not repeated.

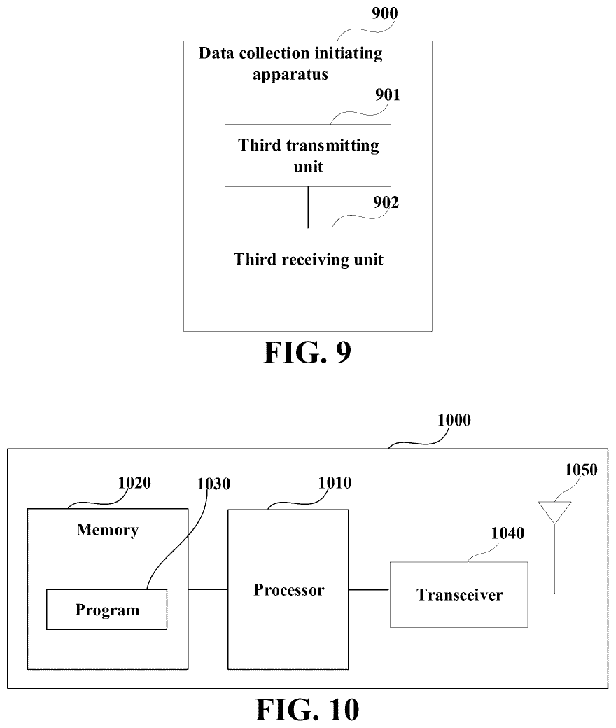

FIG. 9 is a schematic diagram of a data collection initiating apparatus in the embodiments of the present disclosure. As shown in FIG. 9, a data collection initiating apparatus 900 in the embodiments of the present disclosure includes:
a third transmitting unit 901 configured to transmit starting signaling for indicating to perform data collection to a data generation apparatus,
wherein the data generation apparatus transmits request information for collecting data to a model deployment apparatus, receives AI/ML model-related information from the model deployment apparatus, and transmits data to the model deployment apparatus according to the AI/ML model-related information.

In some embodiments, the third transmitting unit 901 further transmits termination signaling for indicating termination of data collection to the data generation apparatus.

In some embodiments, as shown in FIG. 9, the data collection initiating apparatus 900 may further include:
a third receiving unit 902 configured to receive state information for data collection from the data generation apparatus.

Moreover, for the sake of simplicity, FIG. 9 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection is able to be performed between positioning-involved network entities and/or between a network entity and a terminal which are involved in positioning, so as to optimize a wireless positioning AI/ML model, performance of the AI/ML model for wireless positioning is better or thereof generalization is better, whereby a more accurate positioning result is able to be obtained.

### Embodiments of a Seventh Aspect

Embodiments of the present disclosure provide a communication system. FIG. 1 is a schematic diagram of a communication system in the embodiments of the present disclosure. As shown in FIG. 1, the communication system 100 includes a network device 101, a terminal equipment 102 and a positioning server 103. For the sake of simplicity, FIG. 1 only takes a network device and a terminal equipment as examples to describe, but the embodiments of the present disclosure are not limited to this.

In some embodiments, the communication system includes a data generation apparatus 700; a model deployment apparatus 800; and a data collection initiating apparatus 900.

Embodiments of the present disclosure further provide an electronic device, the electronic device e.g. is the data generation apparatus, or the model deployment apparatus, or the data collection initiating apparatus as described above.

FIG. 10 is a schematic diagram of composition of an electronic device in the embodiments of the present disclosure. As shown in FIG. 10, an electronic device 1000 may include: a processor 1010 (such as a central processing unit (CPU)) and a memory 1020; the memory 1020 is coupled to the processor 1010. The memory 1020 may store various data; moreover, further stores a program 1030 for information processing, and executes the program 1030 under the control of the processor 1010.

For example, the processor 1010 may be configured to execute a program to implement the data collection method as described in the embodiments of the first aspect. For example, the processor 1010 may be configured to perform the following control: transmitting request information for collecting data to a model deployment apparatus, receiving AI/ML model-related information from the model deployment apparatus, and transmitting data to the model deployment apparatus according to the AI/ML model-related information.

For another example, the processor 1010 may be configured to execute a program to implement the data collection method as described in the embodiments of the second aspect. For example, the processor 1010 may be configured to perform the following control: receiving request information for collecting data transmitted by a data generation apparatus, transmitting AI/ML model-related information to the data generation apparatus, and receiving data transmitted by the data generation apparatus according to the AI/ML model-related information.

For another example, the processor 1010 may be configured to execute a program to implement the data collection method as described in the embodiments of the third aspect. For example, the processor 1010 may be configured to perform the following control: transmitting starting signaling for indicating to perform data collection to a data generation apparatus, wherein the data generation apparatus transmits request information for collecting data to a model deployment apparatus, receives AI/ML model-related information from the model deployment apparatus, and transmits data to the model deployment apparatus according to the AI/ML model-related information.

In addition, as shown in FIG. 10, the electronic device 1000 may further include: a transceiver 1040 and an antenna 1050, etc., wherein the functions of said components are similar to relevant arts, which are not repeated here. It's worth noting that the electronic device 1000 does not have to include all the components shown in FIG. 9. Moreover, the electronic device 1000 may also include components not shown in FIG. 10, related arts may be referred to.

Embodiments of the present disclosure further provide a computer readable program, wherein when the program is executed in a data generation apparatus, the program enables a computer to execute the data collection method as described in the embodiments of the first aspect, in the data generation apparatus.

Embodiments of the present disclosure further provide a storage medium in which a computer readable program is stored, wherein the computer readable program enables a computer to execute the data collection method as described in the embodiments of the first aspect, in a data generation apparatus.

Embodiments of the present disclosure further provide a computer readable program, wherein when the program is executed in the model deployment apparatus, the program enables a computer to execute the data collection method as described in the embodiments of the second aspect, in the model deployment apparatus.

Embodiments of the present disclosure further provide a storage medium in which a computer readable program is stored, wherein the computer readable program enables a computer to execute the data collection method as described in the embodiments of the second aspect, in a model deployment apparatus.

Embodiments of the present disclosure further provide a computer readable program, wherein when the program is executed in a data collection initiating apparatus, the program enables a computer to execute the data collection method as described in the embodiments of the third aspect, in the data collection initiating apparatus.

Embodiments of the present disclosure further provide a storage medium in which a computer readable program is stored, wherein the computer readable program enables a computer to execute the data collection method as described in the embodiments of the third aspect, in a data collection initiating apparatus.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The logic component is e.g. a field programmable logic component, a microprocessor, a processor used in a computer, etc. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

Regarding the above implementations disclosed in this embodiment, the following supplements are further disclosed:

1. A data collection method, including:
a data generation apparatus transmits request information for collecting data to a model deployment apparatus;
the data generation apparatus receives AI/ML model-related information from the model deployment apparatus; and
the data generation apparatus transmits data to the model deployment apparatus according to the AI/ML model-related information.

2. The method according to Supplement 1, wherein the method further includes:
the data generation apparatus receives starting signaling for indicating to perform data collection from a data collection initiating apparatus.

3. The method according to Supplement 2, wherein the starting signaling includes first triggering information, or the starting signaling includes first triggering information and first cause information associated with the first triggering information.

4. The method according to Supplement 3, wherein the first cause information includes at least one of the following: cell handover, a change in a beam environment, a change in a transmit beam, a change in an AI/ML model lifecycle management phase (such as training, monitoring, inference, etc.), a change in a positioning service quality demand, upgrading of a positioning module, or inability of a preferred device to provide positioning data.

5. The method according to Supplement 2, wherein the method further includes:
the data generation apparatus receives termination signaling for indicating termination of data collection from the data collection initiating apparatus.

6. The method according to Supplement 5, wherein the termination signaling includes second triggering information, or the termination signaling includes second triggering information and second cause information associated with the second triggering information.

7. The method according to Supplement 6, wherein the second cause information includes at least one of the following: completion of data collection, termination of a current wireless positioning service, termination of an AI/ML model service, handover of a cell where the model deployment apparatus is located, a change in a beam environment to which the model deployment apparatus or the data generation apparatus corresponds, or a change in a positioning service quality demand.

8. The method according to any one of Supplements 1 to 7, wherein the data generation apparatus periodically transmits the request information to the model deployment apparatus, or the data generation apparatus aperiodically transmits the request information to the model deployment apparatus.

9. The method according to any one of Supplements 1 to 8, wherein the request information includes triggering request information, or includes triggering request information and additional request information.

10. The method according to Supplement 9, wherein the additional request information includes at least one of the following: data size information, data consistency requirement information, data content information, collection duration information, data quality determination information, data format information, data type information, positioning reference unit (PRU) information, or non-radio access technology (NON-RAT) information.

11. The method according to any one of Supplements 1 to 10, wherein the AI/ML model-related information includes at least one of the following: model configuration information, model input output information, model training information, model inference information, model monitoring information, or information needed for model handover.

12. The method according to Supplement 2, wherein in a case where the data collection initiating apparatus and the model deployment apparatus are located in the same device, the AI/ML model-related information and the starting signaling are transmitted together by the device, or in a case where the data collection initiating apparatus and the model deployment apparatus are not located in the same device, the AI/ML model-related information is transmitted by the model deployment apparatus based on the request information.

13. The method according to Supplement 11, wherein the model configuration information includes general information and/or positioning-specific information.

14. The method according to Supplement 13, wherein the general information includes at least one of the following: data size information, data consistency requirement information, collection duration information, or time limit information.

15. The method according to Supplement 14, wherein the data size information includes at least one of the following: the number of needed valid data, the number of needed samples, or a minimum data amount of needed data,
the time limit information including maximum delay needed for receiving data;
the data consistency requirement information including at least one of the following: information on a change of a mean value of RSRP in a plurality of measurement cycles, information on a change of delay distribution of RSRP, or configuration consistency information of a reference signal for data measurement.

16. The method according to Supplement 13, wherein the positioning-specific information includes at least one of the following: data source information, processing information needed for data transmission, or data quality information.

17. The method according to Supplement 16, wherein the data source information includes at least one of the following: cell identification information, non-radio access technology (NON-RAT) positioning manner information, identification information of a positioning reference unit (PRU), or beam information to which the positioning reference unit (PRU) corresponds;
the processing information needed for data transmission including at least one of the following: information specifying whether data need to be segmented, or information specifying whether the data need to be header compressed;
the data quality information including at least one of the following: information that RSRP is greater than a preset power threshold, information that a plurality of paths of RSRPP are within a preset duration, or information that a probability of a LOS is greater than a preset proportion.

18. The method according to any one of Supplements 1 to 17, wherein the method further includes:
the data generation apparatus transmits state information of data collection to the data collection initiating apparatus or the model deployment apparatus.

19. The method according to Supplement 18, wherein the state information includes: a data collection completion indication or a data collection abnormality indication, wherein the data collection abnormality indication includes common cause information and/or positioning-related cause information.

20. The method according to Supplement 19, wherein the common cause information includes at least one of the following: an insufficient processing capability per unit time, or an insufficient resource capability; and
the positioning-related cause information includes at least one of the following: an inability to provide specified positioning data, an inability to generate data of specified accuracy, or unavailability of a positioning reference unit (PRU).

21. A data collection method, including:
a model deployment apparatus receives request information for collecting data transmitted by a data generation apparatus;
the model deployment apparatus transmits AI/ML model-related information to the data generation apparatus; and
the model deployment apparatus receives data transmitted by the data generation apparatus according to the AI/ML model-related information.

22. The method according to Supplement 21, wherein the data generation apparatus periodically transmits the request information to the model deployment apparatus, or the data generation apparatus aperiodically transmits the request information to the model deployment apparatus.

23. The method according to Supplement 21, wherein the request information includes triggering request information, or includes triggering request information and additional request information.

24. The method according to Supplement 23, wherein the additional request information includes at least one of the following: data size information, data consistency requirement information, data content information, collection duration information, data quality determination information, data format information, data type information, positioning reference unit (PRU) information, or non-radio access technology (NON-RAT) information.

25. The method according to any one of Supplements 21 to 24, wherein the AI/ML model-related information includes at least one of the following: model configuration information, model input output information, model training information, model inference information, model monitoring information, or information needed for model handover.

26. The method according to Supplement 25, wherein the model configuration information includes general information and/or positioning-specific information.

27. The method according to Supplement 26, wherein the general information includes at least one of the following: data size information, data consistency requirement information, collection duration information, or time limit information.

28. The method according to Supplement 27, wherein the data size information includes at least one of the following: the number of needed valid data, the number of needed samples, or a minimum data amount of needed data,
the time limit information including maximum delay needed for receiving data;
the data consistency requirement information including at least one of the following: information on a change of a mean value of RSRP in a plurality of measurement cycles, information on a change of delay distribution of RSRP, or configuration consistency information of a reference signal for data measurement.

29. The method according to Supplement 26, wherein the positioning-specific information includes at least one of the following: data source information, processing information needed for data transmission, or data quality information.

30. The method according to Supplement 29, wherein the data source information includes at least one of the following: cell identification information, non-radio access technology (NON-RAT) positioning manner information, identification information of a positioning reference unit (PRU), or beam information to which the positioning reference unit (PRU) corresponds;
the processing information needed for data transmission including at least one of the following: information specifying whether data need to be segmented, or information specifying whether the data need to be header compressed;
the data quality information including at least one of the following: information that RSRP is greater than a preset power threshold, information that a plurality of paths of RSRPP are within a preset duration, or information that a probability of a LOS is greater than a preset proportion.

31. The method according to any one of Supplements 21 to 30, wherein the method further includes:
the model deployment apparatus receives state information for data collection from the data generation apparatus.

32. The method according to Supplement 31, wherein the state information includes: a data collection completion indication or a data collection abnormality indication, wherein the data collection abnormality indication includes common cause information and/or positioning-related cause information.

33. The method according to Supplement 32, wherein the common cause information includes at least one of the following: an insufficient processing capability per unit time, or an insufficient resource capability; and
the positioning-related cause information includes at least one of the following: an inability to provide specified positioning data, an inability to generate data of specified accuracy, or unavailability of a positioning reference unit (PRU).

34. A data collection method, including:
a data collection initiating apparatus transmits starting signaling for indicating to perform data collection to a data generation apparatus,
wherein the data generation apparatus transmits request information for collecting data to a model deployment apparatus, receives AI/ML model-related information from the model deployment apparatus, and transmits data to the model deployment apparatus according to the AI/ML model-related information.

35. The method according to Supplement 34, wherein the starting signaling includes first triggering information, or the starting signaling includes first triggering information and first cause information associated with the first triggering information.

36. The method according to Supplement 35, wherein the first cause information includes at least one of the following: cell handover, a change in a beam environment, a change in a transmit beam, a change in an AI/ML model lifecycle management phase (such as training, monitoring, inference, etc.), a change in a positioning service quality demand, upgrading of a positioning module, or inability of a preferred device to provide positioning data.

37. The method according to Supplement 34, wherein the method further includes:
the data collection initiating apparatus transmits termination signaling for indicating termination of data collection to the data generation apparatus.

38. The method according to Supplement 37, wherein the termination signaling includes second triggering information.

39. The method according to Supplement 37, wherein the termination signaling includes second triggering information and second cause information associated with the second triggering information.

40. The method according to Supplement 39, wherein the second cause information includes at least one of the following: completion of data collection, termination of a current wireless positioning service, termination of an AI/ML model service, handover of a cell where the model deployment apparatus is located, a change in a beam environment to which the model deployment apparatus or the data generation apparatus corresponds, or a change in a positioning service quality demand.

41. The method according to Supplement 34, wherein in a case where the data collection initiating apparatus and the model deployment apparatus are located in the same device, the AI/ML model-related information and the starting signaling are transmitted together by the device, or in a case where the data collection initiating apparatus and the model deployment apparatus are not located in the same device, the AI/ML model-related information is transmitted by the model deployment apparatus based on the request information.

42. The method according to any one of Supplements 34 to 41, wherein the method further includes:
the data collection initiating apparatus receives state information for data collection from the data generation apparatus.

43. The method according to Supplement 42, wherein the state information includes: a data collection completion indication or a data collection abnormality indication, wherein the data collection abnormality indication includes common cause information and/or positioning-related cause information.

44. The method according to Supplement 43, wherein the common cause information includes at least one of the following: an insufficient processing capability per unit time, or an insufficient resource capability; and
the positioning-related cause information includes at least one of the following: an inability to provide specified positioning data, an inability to generate data of specified accuracy, or unavailability of a positioning reference unit (PRU).

45. A data generation apparatus, including a memory and a processor, the memory storing a computer program, and the processor being configured to execute the computer program to implement the data collection method according to any one of Supplements 1 to 20.

46. A model deployment apparatus, including a memory and a processor, the memory storing a computer program, and the processor being configured to execute the computer program to implement the data collection method according to any one of Supplements 21 to 33.

47. A data collection initiating apparatus, including a memory and a processor, the memory storing a computer program, and the processor being configured to execute the computer program to implement the data collection method according to any one of Supplements 34 to 44.

48. A communication system, including:
the data generation apparatus according to Supplement 45;
the model deployment apparatus according to Supplement 46; and
the data collection initiating apparatus according to Supplement 47.

What is claimed is:

1. A data generation apparatus, comprising:
a transmitter configured to transmit request information for collecting data to a model deployment apparatus; and
a receiver configured to receive AI/ML model-related information from the model deployment apparatus;
wherein the transmitter is further configured to transmit data to the model deployment apparatus according to the AI/ML model-related information.

2. The apparatus according to claim 1, wherein,
the receiver is further configured to receive starting information via LTE/NR downlink or uplink signaling including at least RRC/MAC CE/DCI/UCI for indicating to perform data collection from a data collection initiating apparatus.

3. The apparatus according to claim 2, wherein the starting information comprises first triggering information, or the starting information comprises first triggering information and first cause information associated with the first triggering information.

4. The apparatus according to claim 3, wherein the first cause information comprises at least one of the following: cell handover, a change in a beam environment, a change in a transmit beam, a change in an AI/ML model lifecycle management phase, a change in a positioning service quality demand, upgrading of a positioning module, or inability of a preferred device to provide positioning data.

5. The apparatus according to claim 2, wherein,
the receiver is further configured to receive termination information for indicating termination of data collection from the data collection initiating apparatus.

6. The apparatus according to claim 5, wherein the termination information comprises second triggering information, or the termination information comprises second triggering information and second cause information associated with the second triggering information.

7. The apparatus according to claim 6, wherein the second cause information comprises at least one of the following: completion of data collection, termination of a current wireless positioning service, termination of an AI/ML model service, handover of a cell where the model deployment apparatus is located, a change in a beam environment to which the model deployment apparatus or the data generation apparatus corresponds, or a change in a positioning service quality demand.

8. The apparatus according to claim 1, wherein the transmitter is further configured to periodically transmit the request information to the model deployment apparatus, or the transmitter is further configured to aperiodically transmit the request information to the model deployment apparatus.

9. The apparatus according to claim 1, wherein the request information comprises triggering request information, or comprises triggering request information and additional request information, the request information is transmitted via LTE/NR downlink or uplink signaling including at least RRC/MAC CE/DCI/UCI.

10. The apparatus according to claim 9, wherein the additional request information comprises at least one of the following: data size information, data consistency requirement information, data content information, collection duration information, data quality determination information, data format information, data type information, positioning reference unit information, or non-radio access technology information.

11. The apparatus according to claim 1, wherein the AI/ML model-related information comprises at least one of the following: model configuration information, model input output information, model training information, model inference information, model monitoring information, or information needed for model handover, the AI/ML model-related information is received via LTE/NR downlink or uplink signaling including at least RRC/MAC CE/DCI/UCI.

12. The apparatus according to claim 11, wherein the model configuration information comprises general information and/or positioning-specific information.

13. The apparatus according to claim 12, wherein the general information comprises at least one of the following: data size information, data consistency requirement information, collection duration information, or time limit information,
the data size information comprising at least one of the following: the number of needed valid data, the number of needed samples, or a minimum data amount of needed data,
the time limit information comprising maximum delay needed for receiving data;
the data consistency requirement information comprising at least one of the following: information on a change of a mean value of reference signal received power in a plurality of measurement cycles, information on a change of delay distribution of reference signal received power, or configuration consistency information of a reference signal for data measurement.

14. The apparatus according to claim 12, wherein the positioning-specific information comprises at least one of the following: data source information, processing information needed for data transmission, or data quality information,
the data source information comprising at least one of the following: cell identification information, non-radio access technology positioning manner information, identification information of a positioning reference unit, or beam information to which the positioning reference unit corresponds,
the processing information needed for data transmission comprising at least one of the following: information specifying whether data need to be segmented, or information specifying whether the data need to be header compressed;
the data quality information comprising at least one of the following: information that reference signal received power is greater than a preset power threshold, information that a plurality of paths of reference signal received path power are within a preset duration, or information that a probability of a line of sight is greater than a preset proportion.

15. The apparatus according to claim 2, wherein in a case where the data collection initiating apparatus and the model deployment apparatus are located in the same device, the AI/ML model-related information and the starting information are transmitted together by the device, or in a case where the data collection initiating apparatus and the model deployment apparatus are not located in the same device, the AI/ML model-related information is transmitted by the model deployment apparatus based on the request information.

16. The apparatus according to claim 2, wherein,
the transmitter is further configured to transmit state information of data collection to the data collection initiating apparatus or the model deployment apparatus.

17. The apparatus according to claim 16, wherein the state information comprises: a data collection completion indication or a data collection abnormality indication, wherein the data collection abnormality indication comprises common cause information and/or positioning-related cause information.

18. The apparatus according to claim 17, wherein the common cause information comprises at least one of the following: an insufficient processing capability per unit time, or an insufficient resource capability; and
the positioning-related cause information comprises at least one of the following: an inability to provide specified positioning data, an inability to generate data of specified accuracy, or unavailability of a positioning reference unit.

19. A model deployment apparatus, comprising:
a receiver configured to receive request information for collecting data transmitted by a data generation apparatus; and
a transmitter configured to transmit AI/ML model-related information to the data generation apparatus;
wherein the receiver is further configured to receive data transmitted by the data generation apparatus according to the AI/ML model-related information.

20. A data collection initiating apparatus, comprising:
a data generation apparatus, and
a transmitter configured to transmit starting information for indicating to perform data collection to the data generation apparatus,
wherein the data generation apparatus transmits request information for collecting data to a model deployment apparatus, receives AI/ML model-related information from the model deployment apparatus, and transmits data to the model deployment apparatus according to the AI/ML model-related information.
